(19) United States
(12) Patent Application Publication
(10) Pub. No.: US 2013/0152801 A1
(43) Pub. Date: Jun. 20, 2013

(54) DEVICE FOR HEAT-PROCESSING CO-EXTRUDED SAUSAGES

(71) Applicants: Bernard Cadoret, Mauron (FR); OLivier Marquet, Mauron (FR)

(72) Inventors: Bernard Cadoret, Mauron (FR); OLivier Marquet, Mauron (FR)

(21) Appl. No.: 13/581,879

(22) PCT Filed: Mar. 2, 2011
(86) PCT No.: PCT/EP11/53066

§ 371 Date: Oct. 24, 2012

(30) Foreign Application Priority Data
Mar. 2, 2010 (FR) 1051490

(51) Int. Cl. A23L 1/01

(52) U.S. Cl. CPC A23L 1/0121
USPC 99/406; 99/407; 99/517; 99/443 C; 99/526

(57) ABSTRACT

The invention concerns a heat processing device (100, 200) for co-extruded sausages (S), said device (100, 200) comprising in series:
a precooking device (104) intended to precook the sausages (S) deposited by a device (102) and consisting of a hot-water bath, the precooking device (104) taking the form of a chute (114) having a zero or slightly descending slope between an intake area (116) where the sausages (S) are deposited by the device (102) and an outlet area (118) where the sausages (S) leave the precooking device (104), the precooking device (104) comprising ejection means (124) designed to eject water upstream of the intake area (116) so that the water stream generated has an orientation substantially parallel to the longitudinal axis of the chute (114),
a cooking device (108) intended to cook the sausages (S) thus precooked and consisting of a second hot-water bath, and
a discharge device (112) intended to discharge the sausages (S) thus processed.

The present invention concerns a device for the heat processing of sausages as well as a method for the heat processing of sausages implemented by means of such a heat processing device.

The invention is more particularly suitable in the context of co-extruded sausages. Such sausages comprise a core of food products and an external skin consisting of a gel, for example of the alginate or collagen type.

Such sausages are produced continuously, and cut to length.

So that the sausage thus cut holds together, it is placed on a support and passes through a cooking chamber in a steam or dry environment, where it undergoes various heat treatments so as to stabilise the gel and coagulate the surface proteins.

The sausage thus solidified on the surface can thus be handled more easily.

Depositing products at the output of pushing means on a rigid support causes high mechanical forces on the product, which has a tendency to deform, and cooking in a steam or dry environment chamber causes partial drying of the product having a significant induced effect on the cooking efficiency.

One object of the present is to propose a heat processing device, in particular for sausages of the co-extruded sausage type, said heat processing device comprising in series:
a precooking device intended to precook the sausages deposited by a device and consisting of a hot-water bath, the precooking device taking the form of a chute having a zero or slightly descending slope between an intake area where the sausages are deposited by the device and an outlet area where the sausages leave the precooking device, the precooking device comprising ejection means designed to eject water upstream of the intake area so that the water stream generated has an orientation substantially parallel to the longitudinal axis of the chute,
a cooking device intended to cook the sausages thus precooked and consisting of a second hot-water bath, and
a discharge device intended to discharge the sausages thus processed.

Advantageously the heat processing device comprises, between the cooking device and a discharge device, a cooling device intended to cool the sausages thus cooked and consisting of a cold-water bath.

Advantageously, the ejection means take the form of a water reservoir and an ejection nozzle designed to eject the water from said water reservoir.

Advantageously, the chute takes the form of a spiral.

Advantageously, the intake area is situated at the periphery of the spiral, and the outlet area is situated at the centre of the spiral.

Advantageously, the cooking device and the cooling device each comprise a cooking and respectively cooling vessel, and a driving device provided for driving the sausages between a loading area and a discharge area of the corresponding device.

Advantageously, the driving device takes the form of a succession of blades and a motorised driving means.

Advantageously, the heat processing device comprises, just downstream of the precooking device, a transfer device having a transfer belt and intended to transfer the sausages thus precooked.

Advantageously, the downstream end of the transfer belt is driven in a reciprocating angular movement intended to distribute the sausages horizontally downstream of said transfer belt.

Advantageously, the heat processing device comprises, just downstream of the transfer belt, a drying device intended to dry the sausages thus transferred and having blowing nozzles intended to blow hot dry air onto the sausages thus transferred.

Advantageously, the drying device comprises at least one conveyor belt and, progressing downstream, each conveyor belt is situated at a lower height with respect to the outlet from the transfer or conveying belt that precedes it.

Advantageously, the drying device comprises a cover that at least partly covers the transfer belt.

The features of the invention mentioned above, as well as others, will emerge more clearly from a reading of the following description of an example embodiment, said description being given in relation to the accompanying drawings, among which:

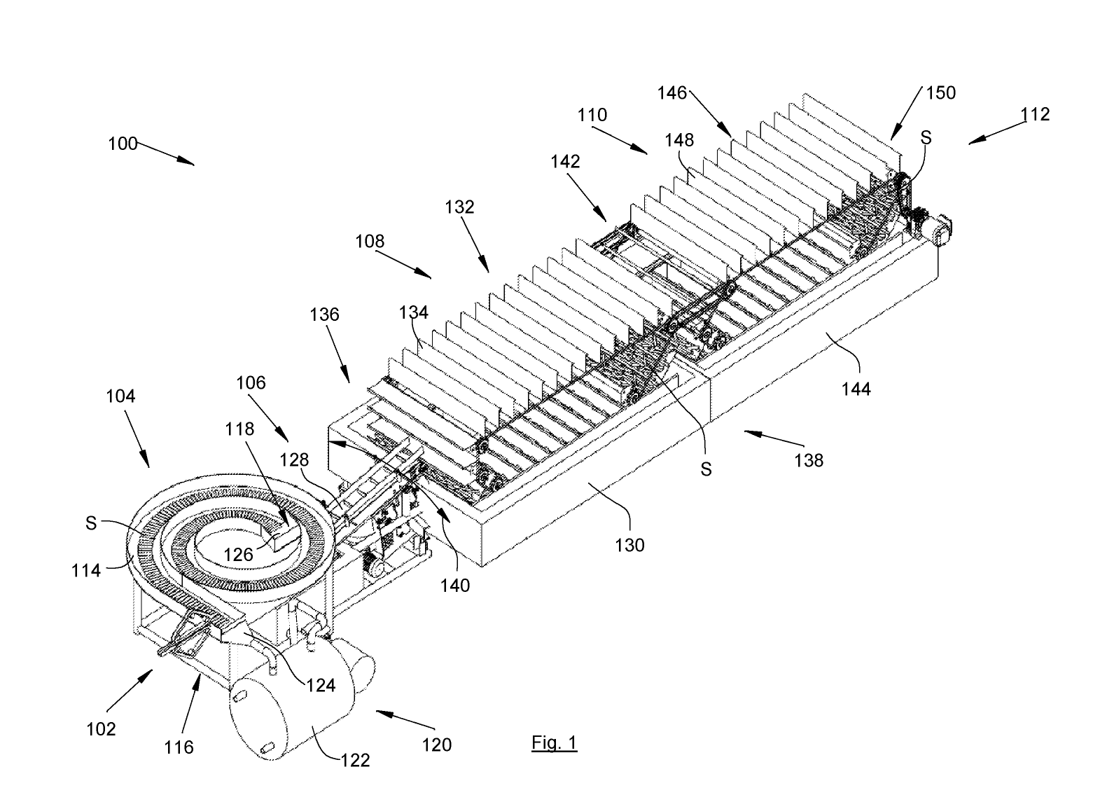

FIG. 1 shows a device for the heat processing of sausages according to a first embodiment of the invention,

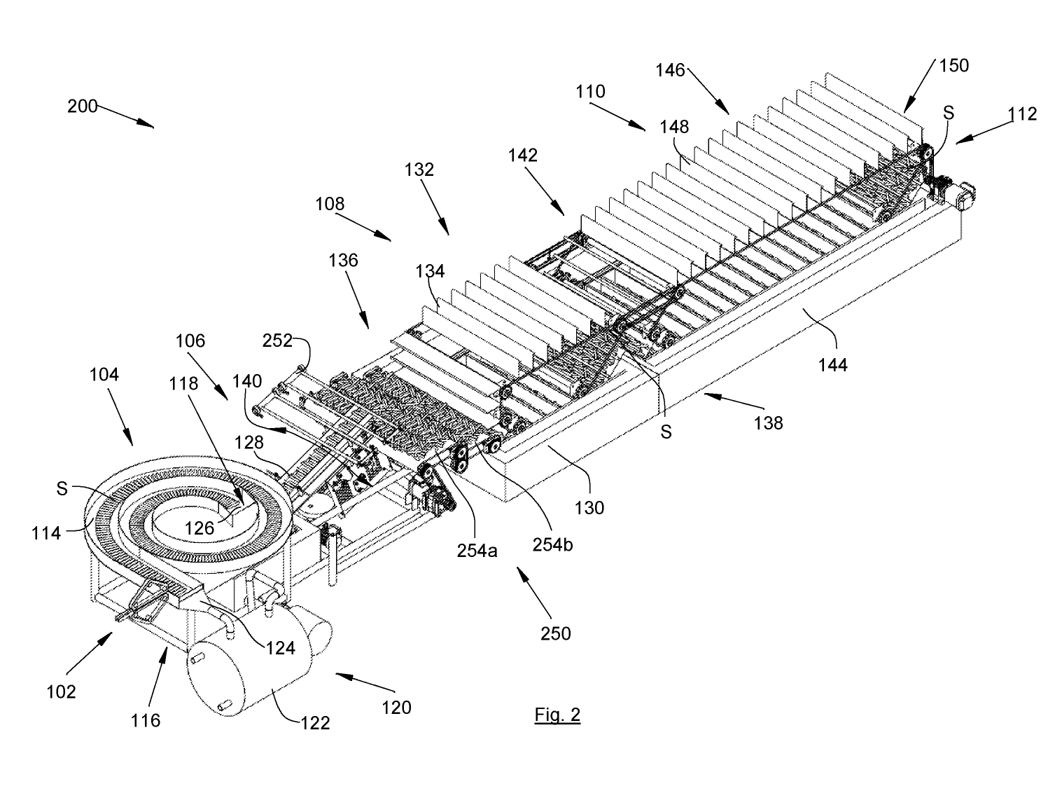

FIG. 2 shows a device for the heat processing of sausages according to a second embodiment of the invention, and

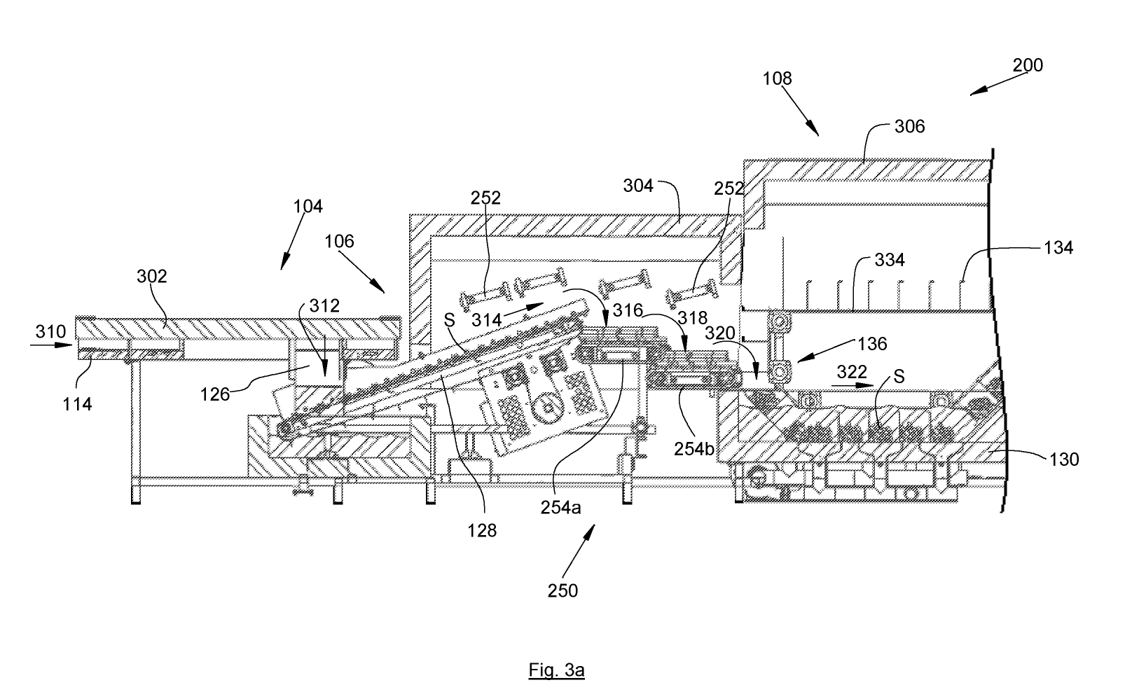

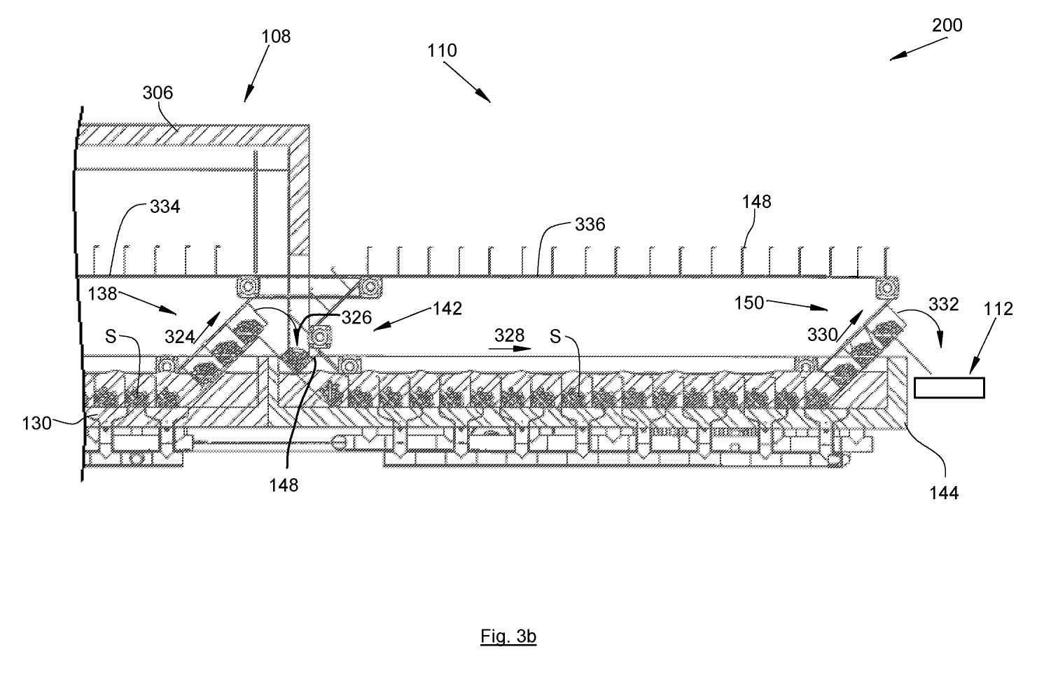

FIGS. 3a and 3b show a section along a vertical plane of the device for the heat processing of sausages according to a second embodiment of the invention.

In the following description, the terms relating to a position are taken with reference to a device for the heat processing of sausages arranged in the operating position, that is to say as shown in FIG. 1. For example, the concepts “upstream” and “downstream” are with reference to the direction of progression of the sausages in the heat processing device.

For ease of understanding, the covers on the heat processing devices in FIGS. 1 and 2 have been removed.

FIG. 1 shows a heat processing device 100 for sausages S of the co-extruded sausage type with an external gel skin, of the alginate or collagen type.

FIG. 2 shows a heat processing device 100 according to another embodiment of the invention and FIGS. 3a and 3b show the heat processing device 200 in cross section. The elements that are identical to those in FIG. 1 keep the same reference.

Downstream of a device 102 intended to cut and transfer the sausages S, the heat processing device 100 comprises in series:
a precooking device 104 intended to precook the sausages S deposited by the device 102 and consisting of a first hot-water bath,
a cooking device 108 intended to cook the sausages S thus precooked and consisting of a second hot-water bath, and
a discharge device 112 intended to discharge the sausages S thus processed.

The device 102 consists of a conveyor with a driven belt. The sausages S that are manufactured continuously are arranged on the conveyor and are driven by the first driving device, where they are cut to the desired length.

At the outlet from the device 102, the sausages S fall one after the other into the precooking device 104, which is filled with hot water the temperature of which is around 90° C. The outlet rhythm of the sausages S from the device 102 is for example around 400 sausages/minute.

The travel of the sausages S through the precooking device 104 has a duration of around 60 seconds.

The precooking device 104 takes the form of a chute 114 the bottom of which has a zero or slightly downward slope between an intake area 116 where the sausages S are deposited by the device 102 and an outlet area 118 where the sausages S leave the precooking device 104.

To drive the sausages S in the chute 114, the precooking device 104 also comprises a water feed device 120. The water feed device 120 comprises here a reservoir 122 for heating the water and an ejection nozzle 124. The ejection nozzle 124 ejects the water from the hot-water reservoir 122 just upstream of the intake area 116.

The ejection nozzle 124 is oriented so that the water stream generated has an orientation substantially parallel to the longitudinal axis of the chute 114 at the intake area 116. The flow rate of water leaving the ejection nozzle 124 is for example around 5 m³/h. The ejection nozzle 124 and the hot-water reservoir 122 thus constitute ejection means designed to eject water upstream of the intake area 116 so that the water stream generated has an orientation substantially parallel to the longitudinal axis of the chute 114.

In FIGS. 1 and 2, each sausage S is shown with its longitudinal axis oriented at 90° with respect to the axis of the chute 114 at the intake area 116, but it is also possible to arrange the sausages S parallel to the longitudinal axis of the chute 114.

The stream of water created by the ejection nozzle 124 drives the sausages S one after the other. It should be noted that the device functions at the following rates both with sausages S that float and with sausages S that sink during the travel through the precooking device 104.

The passage of the sausages S through the water of the chute 114 stabilises the gel and proteins on the surface and thus stiffens the sausages S when they leave the device 2, preventing them from being deformed.

The sausages S are thus positioned one after the other rather than one on the other, which allows homogeneous heat processing of each sausage S.

For a maximum saving of space, the chute 114 takes the form of a spiral, but other geometries are possible. The intake area 116 is situated at the periphery of the spiral and the outlet area 118 is situated at the centre of the spiral.

The sausages S are discharged through a hole 124 produced in the bottom of the chute 114 at the outlet area 118, and here fall onto a transfer belt 128 of a transfer device 106 that is placed just downstream of the precooking device 104. The transfer device 106 is intended for transferring the precooked sausages S.

The sausages S are transported on the transfer belt 128 as far as a loading area 136 of the cooking device 108.

In another embodiment, it is possible to provide for the sausages S, at the outlet from the precooking area 104, to fall directly at the loading area 136 of the cooking device 108.

The stiffened sausages S fall into the cooking device 108, which consists of a cooking vessel 130 filled with hot water at approximately 90° C. and a second driving device 132. The second driving device 132 takes the form of a succession of blades 134 and a motorised driving means that drives the blades 134 in movement between the loading area 136 and a discharge area 138 of the cooking device 108 in order to move the sausages S from the loading area 136 to the discharge area 138.

The speed of movement of the blades 134 is such that the sausages S reside for approximately ten minutes in the cooking device 108. The parameters for the speed of movement of the base 134 and temperature of the cooking hot water are preferably determined so that the core of each sausage S reaches a temperature of around 72° C. when it passes through the discharge area 138.

In order to distribute the sausages S laterally downstream of the transfer belt 128, and in particular over the width of the cooking device 108, the downstream end of the transfer belt is driven in a reciprocating rotary movement represented by the double arrow 140. The downstream end of the transfer belt 128 thus undergoes an angular movement.

After the loading area 136, a perforated metal sheet can cover the blades 134 so as to guarantee that the sausages remain immersed throughout the whole of the cooking cycle.

The cooking water is recovered by overflow into the peripheral area of the cooking device 108, reheated continuously on a device similar to that shown for the precooking device 104 by the reference 122 and then re-injected at multiple points at the bottom part under the sausages S so as to generate a turbulence assisting the homogeneous heat processing of the sausages S. Where applicable, it is possible to increase the turbulence by producing bubbling with air injected into the water recirculation pipework by means of a device of the venturi type.

In the embodiment of the invention presented in FIGS. 1, 2 and 3b, the heat processing device 100 comprises, between the cooking device 108 and the discharge device 112, a cooling device 110 intended to cool the cooked sausages S and consisting of a cold-water bath.

In another embodiment of the invention that is not shown, the sausages S can be discharged by the discharge device 112 directly at the outlet from the cooking device 108. The discharge device 112 can take for example the form of a conveyor belt that transfers the sausages S to a subsequent processing station, such as for example a packaging station and then optionally a cooling station.

At the outlet from the discharge area 138, the sausages S are transferred to a loading area 142 of the cooling device 110.

The cooked sausages S fall into the cooling device 110, which consists of a cooling vessel 144 filled with cold water at approximately 1° C. and a third driving device 146. The third driving device 146 takes the form of a succession of blades 148 and a motorised driving means that drives the blades 148 in movement between the loading area 142 and a discharge area 150 of the cooling device 110 in order to move the sausages S from the loading area 142 to the discharge area 150.

The speed of movement of the blades 148 is such that the sausages S reside in the cooling device 110 for approximately 15 minutes. The parameters of speed of movement of the blades 148 and temperature of the cooling cold water are determined so that the core of the sausages S reaches a temperature of around 5° C. when they pass through the discharge area 150.

After the loading area 142, a perforated metal sheet may cover the blades 148 so as to guarantee that the sausages remain immersed throughout the whole of the cooling cycle.

The cooling water is recovered by overflow into the peripheral area of the cooling device 110, continuously cooled on a device of the plate exchanger type and re-injected at a number of points at the bottom part under the sausages S so as to generate a turbulence assisting the homogeneous heat processing of the sausages S. Where appropriate, it is possible to increase the turbulence by effecting a bubbling with air injected into the water recirculation pipework by means of a device of the venturi type.

At the outlet from the discharge area 150, the sausages S are transferred to the discharge device 112 which, as before, can take the form of a conveyor belt that transfers the sausages S to a subsequent processing station, such as for example a packaging station.

The heat processing device 100 and the heat processing method that is implemented therein afford regular processing of the sausages S while guaranteeing a high efficiency and an absence of deformation of said sausages S.

After the sausages S arrive at length at the device 102, the heat processing method comprises:
a step of deposition of the sausages S by the device 102 in the precooking device 104,
a step of precooking of the sausages S in the precooking device 104,
a step of emergence of the sausages S from the precooking device 104,
a step of deposition of the sausages S in the cooking device 108,
a step of cooking the sausages S in the cooking device 108,
a step of emergence of the sausages S from the cooking device 108, and
a step of discharge of the sausages S by the discharge device 112.

When the heat processing device 100 comprises, between the cooking device 108 and the discharge device 112, a cooling device 110, the method comprises, between the step of emergence of the sausages S from the cooking device 108 and the step of discharge of the sausages S by the discharge device 112:
a step of deposition of the sausages S in the cooling device 110,
a step of cooling of the sausages S in the cooling device 110, and
a step of emergence of the sausages S from the cooling device 110.

When at the outlet from the precooking area 104 the sausages S are transferred by the transfer belt 128 of the transfer device 106, the heat processing method comprises, between the step of emergence of the sausages S from the precooking device 104 and a separate deposition of the sausages S in the cooking device 108, a step of transfer of the sausages by the transfer belt 128. The transfer step consists of a step of reception on the transfer belt 128, a step of movement of the sausages S on the transfer belt 128 and a step of deposition of the sausages S at the outlet from the transfer belt 128. During the transfer step, the transfer belt 128 is preferably subjected to an angular movement in order to obtain a distribution of the sausages over the width of the cooking device 108.

In the embodiment of the invention presented in FIG. 1, the step of deposition of the sausages S takes place in the cooking device 108.

The heat processing device 200 of FIG. 2 is differentiated from the heat processing device 10 of FIG. 1 through the presence, just downstream of the transfer belt 128, of a drying device 250 intended to dry the sausages S before they pass through the cooking device 108.

The drying device 250 makes the colour of the sausages S uniform over their entire external surface.

The drying is done here in a dry heat environment the temperature of which is around 85° C. for approximately 5 minutes.

The drying device 250 comprises at least one conveyor belt 254a, 254b intended to take over the sausages S at the outlet from the transfer belt 128 and to deposit them at the loading area 136 of the cooking device 108.

The drying device 250 also has blowing nozzles 252 that are intended to blow hot dry air onto the sausages S transferred by the transfer belt 128 and each conveyor belt 254a, 254b.

The or each conveyor belt 254a, 254b is driven in movement by a motorised driving means.

The sausages S are deposited on the first conveyor belt 254a and over the entire width thereof by means of the angular movement of the transfer belt 128.

In the embodiment of the invention, the drying device 250 comprises two successive conveyor belts 154a and 154b. Thus, following the first conveyor belt 154a, the sausages S are deposited on the second conveyor belt 154b, which brings them as far as the loading area 136.

The area for receiving the sausages S on the second conveyor belt 154b is at a height less than the area discharging the sausages S from the first conveyor belt 154a. Thus, on passing from the first conveyor belt 154a to the second conveyor belt 154b, the sausages S are turned over in order to expose another part of their surface to drying and thus to prevent the appearance of differently coloured areas.

To ensure a good turning over of the sausages S the difference in height between the two conveyor belts 154a and 154b is for example at a minimum around 100 mm

In other words, progressing downstream, each conveyor belt 254a, 254b is situated at a lower height with respect to the outlet from the transfer belt 128 or conveyor belt 254a that precedes it.

The movement of the sausages S on the conveyor belt 254a and 254b is here a horizontal movement but it is possible to provide for each conveyor belt 254a, 254b to have a slightly rising slope.

In the same way, the drying device 250 has here two conveyor belts 254a and 254b, but it may have more of them.

The air is taken up in the drying device 250, dried and then reheated before once again being blown onto the sausages S.

The heat processing method thus comprises, between the step of depositing the sausages S at the outlet from the transfer belt 128 and the step of depositing the sausages S in the cooking device 108, a step of drying the sausages S in the drying device 250.

The successive descents of the sausages S between the transfer belt 128 and the successive conveyor belt or belts 254a and 254b constitute a step of stirring the sausages S that takes place during the drying step.

FIG. 3a and FIG. 3b show the heat processing device 200 with the covers in place. The remainder of the description relates particularly to the heat processing device 200 but it also applies in the same way to the heat processing device 100.

In order to limit thermal losses during the method of heat processing of the sausages S, the precooking device 104, the drying device 250 and the cooking device 108 each have a cover respectively referenced 302, 304 and 306.

The cover 302 covers the chute 114.

The cover 304 covers the drying device 250 and in particular the conveyor belts 254a, 254b. In order to reduce the length of the heat processing device 200 while preserving the drying time for the sausages S, the transfer belt 128 is also placed at least partly under the cover 304 and the passage from the transfer belt 128 to the first conveyor belt 154a constitutes a first turning over of the sausages S, which also tends to improve the process of making the colour of the sausages S more uniform.

The cover 306 covers the cooking vessel 130.

The covers 302, 304 and 306 are removable in order to assist the cleaning and maintenance of the heat processing device 200.

The arrows 310 to 332 show the travel of the sausages S in the heat processing device 200.

The arrow 310 shows the deposition of the sausages S from the device 102 in the chute 114 of the precooking device 104.

The arrow 312 shows the discharge, through the hole 126, of the sausages S, which fall onto the transfer belt 128 of the transfer device 106.

The arrow 314 shows the movement of the sausages S on the transfer belt 128.

The arrow 316 shows the fall of the sausages S from the transfer belt 128 onto the first conveyor belt 254a.

The arrow 318 shows the fall of the sausages S from the first conveyor belt 254a onto the second conveyor belt 254b.

The arrow 320 shows the fall of the sausages S from the second conveyor belt 254b into the cooking vessel 130. The sausages S are received by a blade 134 that damps the fall.

The arrow 322 shows the movement of the sausages S in the cooking vessel 130. The sausages S are pushed by the blade 134 that follows the blade 134 that damped their fall. The space between two successive blades 134 delimits a particular compartment and guarantees a low distribution of the residence times of the sausages S.

The arrow 324 shows the exit of the sausages S from the cooking vessel 130 and their arrival at the discharge area 138.

The arrow 326 shows the passage of the sausages S from the discharge area 138 to the loading area 142 of the cooling device 110. The sausages S fall into the cooling vessel 144. The sausages S are received by a blade 148. The space between two successive blades 148 delimits a particular compartment and guarantees a low distribution of the residence times of the sausages S.

The arrow 328 shows the movement of the sausages S in the cooling vessel 144. The sausages S are pushed by the blade 148 that follows the blade 148 that damped their fall.

The arrow 330 shows the exit of the sausages S from the cooling vessel 144 and their arrival at the discharge area 150.

The arrow 332 shows the passage of the sausages S from the discharge area 150 to the discharge device 112.

In order to limit the expenditures of energy related to the maintenance of the temperatures of the various liquids, each of them flows in a closed loop, where a temperature maintenance device is provided, whether it be a heating or cooling element.

The water circulates through various filters and treatment means so that it has impurities and microbial elements removed.

In the same way, the drying air blown by the blowing nozzles 252 is recycled, dehydrated and then reheated before blowing onto the sausages S.

During the precooking step in the precooking device 104, various ingredients can be added to the precooking water. These ingredients are for example additives, liquid smoke, dyes, etc.

The motorised means of driving the blades 134 and 148 here take the form of a system with chains 334, 336 on which the blades 134, 148 are fixed and a motor driving the chain system 334, 336.

Naturally, the present invention is not limited to the examples and embodiments described and depicted but is capable of numerous variants accessible to persons skilled in the art.

The heat processing device 100 presented makes it possible to obtain a throughput of 400 sausages per minute. It is of course possible to juxtapose several precooking devices 104 in parallel. The sausages S coming from a precooking device 104 are tipped onto one or more transfer devices 106 and then optionally into a drying device 250.

The sausages S coming from each transfer 106 or drying 250 device are then tipped into the same cooking device 108 and then into the same cooling device 110 having larger dimensions in order to receive this flow of additional sausages S. The processing rates are then increased; for example with two precooking devices 104, it is possible to process approximately 800 sausages per minute.

It is also possible to provide for each precooking device 104 to be fed with sausages S by more than one device 102. Thus, in the above embodiment with two precooking devices 104, where each is supplied by two devices 102, it is possible to obtain rates of around 1600 sausages/minute.

1. Heat processing device (100, 200), in particular for sausages of the co-extruded sausage (S) type, said heat processing device (100, 200) comprising in series:
a precooking device (104) intended to precook the sausages (S) deposited by a device (102) and consisting of a hot-water bath, the precooking device (104) taking the form of a chute (114) having a zero or slightly descending slope between an intake area (116) where the sausages (S) are deposited by the device (102) and an outlet area (118) where the sausages (S) leave the precooking device (104), the precooking device (104) comprising ejection means (124) designed to eject water upstream of the intake area (116) so that the water stream generated has an orientation substantially parallel to the longitudinal axis of the chute (114),
a cooking device (108) intended to cook the sausages (S) thus precooked and consisting of a second hot-water bath, and
a discharge device (112) intended to discharge the sausages (S) thus processed.

2. Heat processing device (100, 200) according to claim 1, characterised in that it comprises, between the cooking device (108) and the discharge device (112), a cooling device (110) intended to cool the sausages (S) thus cooked and consisting of a cold-water bath.

3. Heat processing device (100, 200) according to claim 1, characterised in that the ejection means (124) take the form of a water reservoir (122) and an ejection nozzle (124) provided for ejecting the water from said water reservoir (122).

4. Heat processing device (100, 200) according to claim 1 characterised in that the chute (114) takes the form of a spiral.

5. Heat processing device (100, 200) according to claim 4, characterised in that the intake area (116) is situated at the periphery of the spiral, and the outlet area (118) is situated at the centre of the spiral.

6. Heat processing device (100, 200) according to claim 1, characterised in that the cooking device (108) and the cooling device (110) each comprise a cooking (130) and respectively cooling (144) vessel, and a driving device (132, 146) provided for driving the sausages (S) between a loading area (136, 142) and a discharge area (138, 150) of the corresponding device (108, 110).

7. Heat processing device (100, 200) according to claim 6, characterised in that the driving device (132, 146) takes the form of a succession of blades (134, 148) and a motorised driving means.

8. Heat processing device (100, 200) according to claim 1, characterised in that it comprises, just downstream of the precooking device (104), a transfer device (106) having a transfer belt (128) and intended to transfer the sausages (S) thus precooked.

9. Heat processing device (100, 200) according to claim 8, characterised in that the downstream end of the transfer belt (128) is driven in an angular reciprocating movement (140) intended to horizontally distribute the sausages (S) downstream of said transfer belt (128).

10. Heat processing device (200) according to claim 8, characterised in that it comprises, just downstream of said transfer belt (128), a drying device (250) intended to dry the sausages (S) thus transferred and having blowing nozzles (252) intended to blow hot dry air onto the sausages (S) thus transferred.

11. Heat processing device (200) according to claim 10, characterised in that the drying device (250) comprises at least one conveyor belt (254a, 254b), and in that, progressing downstream, each conveyor belt (254a, 254b) is situated at a lower height with respect to the outlet from the transfer belt (128) or conveyor belt (254a) preceding it.

12. Heat processing device (200) according to claim 10, characterised in that the drying device (250) comprises a cover (304) that at least partly covers the transfer belt (128).
